(19) United States
(12) Patent Application Publication
(10) Pub. No.: US 2023/0105634 A1
(43) Pub. Date: Apr. 6, 2023

(54) Multiphase Flowmeter

(71) Applicant: Brown Hawk Technologies, LLC, Santa Barbara, CA (US)

(72) Inventors: Christopher Joseph Brown, Santa Barbara, CA (US); Najmeh Brown, Santa Barbara, CA (US)

(73) Assignee: Brown Hawk Technologies, LLC, Santa Barbara, CA (US)

(21) Appl. No.: 17/494,706

(22) Filed: Oct. 5, 2021

(51) Int. Cl. G01F 1/74; G01F 1/44

(52) U.S. Cl. CPC G01F 1/74; G01F 1/44; G01F 1/50

(57) ABSTRACT

A multiphase flowmeter may include a circuit including a pressure sensor configured to determine pressure data associated with a fluid mixture flowing through a chamber. The circuit may include one or more position sensors configured to determine position data associated with a position of a movable element that is configured to move within the chamber in response to pressure of the fluid mixture. The circuit may include a processor to determine a flow rate of the fluid mixture based on the pressure data and the position data and first volumes of gas and liquid within the fluid mixture based on frequency data determined from the position data. The processor may be configured to determine second volumes of water and oil within the fluid mixture based on one or more of a cut sensor or a change in an electrical parameter of the one or more position or other sensors.

### FIELD

The present disclosure is generally related to flowmeters, and more particularly to multiphase flow meters that can be used in conjunction with fluid mixtures, such as crude oil mixtures.

### BACKGROUND

Accurate measurements of flowrate of crude oil mixtures (oil, gas, water, and debris) in a pipeline has been one of the biggest challenges facing the oil industry. Historically, the crude mixture may be separated into single-phase component streams so that, after separation, each single-phase component stream may be measured using a metering device for that type of stream to determine the flow rate and the cut for a sampling period. In many implementations, separation and metering may be performed for brief sample periods of time and periodically, and in the intervening non-metered time periods, the volume and flowrate may be estimated based on the measurements taken during the sampling period.

To accurately measure gas and oil production (for example, plus or minus three percent for gas and less than one percent for oil), a field operator may have to separate the gas and oil into single-phase components using large production separators. The single-phase component streams may then be measured using conventional single-phase flow meters, such as orifice plates and Coriolis flowmeters for oil-phase steams and turbine or ultrasonic flowmeters for gas phase streams.

Test separators have traditionally been used to determine the oil-gas water output from an individual well on a periodic basis. Such separators are typically large and can be rotated from well to well and moved from location to location to perform periodic measurements. However, such measurements disrupt normal operations, and may require flowline rerouting through the separator. Conventionally, such measurements are relied upon to estimate the cut, for example, during periods where the fluid mixture is not measured, assuming that any variation in the cut over time may be ignored.

### SUMMARY

Embodiments of a multiphase flow meter are described below that may be coupled to a well, in-line with downstream components, and that may utilize internal geometries of the fluid flow path to enable separation of entrained gas from the fluid mixture and measurement of the separated gas as well as measurement of other components of the fluid mixture. In some implementations, movement of a valve element may be monitored to determined gas and fluid volume and flowrates and one or more additional sensors may be used to determine cut data from the fluid stream.

In some implementations, a multiphase flow meter may be implemented as a check valve. The multiphase flow meter may include an inlet, an outlet, and a valve chamber extending between the inlet and the outlet. The valve chamber may include a throat (a narrowing constriction) including a seat. The multiphase flow meter may include a check disk configured to move into or out of engagement with the seat to close or open a fluid flow path from the inlet to the outlet. The valve chamber may have a cross-sectional area that is greater than that of the inlet or the outlet, providing an expansion chamber that reduces the fluid pressure and encourages release of the entrained gas. The multiphase flow meter may include a sensor assembly including a first sensor configured to determine first data corresponding to a position of the check disk and at least one second sensor configured to determine second data corresponding to one or more of a fluid pressure, a dielectric constant, temperature, or another parameter. The sensor assembly may include a processor coupled to the first sensor and the second sensor and configured to determine gas flow and fluid flow based on the first and to determine the cut of the fluid based on the second data.

In some implementations, a multiphase flowmeter may include an inlet configured to receive a fluid mixture, an outlet configured to provide the fluid mixture to a conduit, and a chamber extending between the inlet and the outlet. The flowmeter may include a seat defining a throat within the chamber and a movable element biased against the seat and configured to move in response to pressure of the fluid mixture. The flowmeter may include a circuit including one or more position sensors to determine position data related to a position of the movable element and at least one pressure sensor configured to determine pressure data associated with the fluid mixture in the chamber. The circuit may include a processor coupled to the one or more position sensors and to the at least one pressure sensor. The processor may be configured to determine a flow rate and cut data of the components of the fluid mixture that is flowing through the chamber based on the position data and the pressure data.

In other implementations, a multiphase flowmeter may include a circuit including a pressure sensor configured to determine pressure data associated with a fluid mixture flowing through a chamber from an inlet to an outlet. The circuit may include one or more position sensors configured to determine position data associated with a position of a movable element within the chamber that is configured to move in response to pressure of the fluid mixture. The circuit may include a processor configured to determine a flow rate of the fluid mixture based on the pressure data and the position data and first volumes of gas and liquid within the fluid mixture based on frequency data determined from the position data. The processor may be configured to determine second volumes of water and oil within the fluid mixture based on one or more of a cut sensor or a change in an electrical parameter of the one or more position sensors.

In still other implementations, a multiphase flowmeter may include a valve and a circuit. The valve may include an inlet coupled to a first conduit to receive a fluid mixture, an outlet above the inlet chamber and configured to provide the fluid mixture to a second conduit, and a chamber extending between the inlet and the outlet. The valve may include a seat defining a throat within the chamber and a movable element within the chamber and biased against the seat. The movable element may be configured to move in response to pressure from the fluid mixture. The circuit may include a pressure sensor coupled to the chamber and configured to determine pressure data associated with the fluid mixture. The circuit may include one or more position sensors configured to determine position data associated with a position of the movable element. The circuit may include a processor configured to determine a flow rate of the fluid mixture based on the pressure data and the position data, a gas volume within the fluid mixture based on oscillations or vibrations of the movable element determined from the position data, and a cut of oil and water within the fluid mixture based on an electrical parameter determined from the one or more position sensors.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a system including a plurality of valves coupled between fluid sources and a common conduit.

FIG. 2 depicts a block diagram of a multiphase flowmeter, in accordance with certain embodiments of the present disclosure.

FIG. 3 depicts a diagram of a multiphase flowmeter including a valve, in accordance with certain embodiments of the present disclosure.

FIG. 4A depicts a portion of the valve of FIG. 2, in accordance with certain embodiments of the present disclosure.

FIG. 4B depicts a Venturi tube model of the valve of FIGS. 2 and 4A.

FIG. 5 depicts a partial block diagram and partial cross-sectional diagram of a multiphase flowmeter including a pair of position sensors that may be used to determine a position of a movable element (such as a check disk of a valve), in accordance with certain embodiments of the present disclosure.

FIG. 6 depicts a block diagram of a multiphase flowmeter according to one of FIGS. 2-5, in accordance with certain embodiments of the present disclosure.

FIG. 7 depicts a block diagram of a system including a control system coupled to one or more multiphase flowmeters, in accordance with certain embodiments of the present disclosure.

FIG. 8 depicts a block diagram of a system including a computing device coupled to one or more of the multiphase flowmeter of any of FIGS. 2-6 or the control system of FIGS. 6 and 7, in accordance with certain embodiments of the present disclosure.

FIG. 9 depicts a graph of frequency versus time for oil, gas, and water passing through the valve assembly of FIG. 2 coupled to a pump jack well, in accordance with certain embodiments of the present disclosure.

FIG. 10 depicts a graph of frequency versus time for oil, gas, and water passing through the valve assembly of FIG. 2 coupled to a progressive cavity pump well, in accordance with certain embodiments of the present disclosure.

FIG. 11 is a flow diagram of a method of providing an output indicative of a multiphase measurement, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of a multiphase flowmeter are described below that may be configured to determine the flowrate and volume of gas, water, and oil in a fluid mixture without separating the fluid mixture into its single phases. In some implementations, the multiphase flowmeter may be implemented as a check valve to provide both check valve functionality and flow metering.

In some implementations, the flowmeter may include an inlet, an outlet, and a fluid chamber extending between the inlet and the outlet. The flowmeter may include a movable element within the chamber that is configured to move in response to pressure of the fluid mixture. The flowmeter may include one or more position sensors configured to determine the position of the movable element within the chamber and at least one pressure sensor to determine a fluid pressure associated with one or more of the inlet, the outlet, or the chamber. The flowmeter may also include a circuit configured to determine the volume and flowrate of gas, water, and oil within the fluid mixture based on the position data, the pressure data, and other data determined from the sensors. In some implementations, the moveable element may include a check disk of a valve.

In a crude oil production environment, the crude mixture may include water, oil, entrained gas, and debris. Conventionally, to determine the cut of the various components of the crude mixture, the mixture is separated into its single-phase components. The multiphase flowmeter described below enables multiphase phase measurements based on one or more of the position of a movable element (which moves in response to fluid pressure and which may be biased against the fluid flow), a pressure of the fluid mixture, a dielectric of the fluid, another parameter, or any combination thereof. In an example, as the fluid mixture flows through the flowmeter, the movable element may move in response to the pressure of the fluid mixture.

In some implementations, the chamber that couples the inlet to the outlet through the multiphase flowmeter may have a larger cross-sectional area (larger volume) than the inlet or outlet, providing an expansion chamber that may cause the entrained gas to be released from the fluid flow. The released gas may be more compressible than the fluid and may move at a faster rate that the fluid. The combination of the faster flow rate and the compressibility may cause the moveable element to move back and forth rapidly, and the frequency of the oscillations or vibrations determined from the position data associated with the movable element may be used to determine the volume of the gas in the fluid mixture. As used herein, the term “oscillation” may refer to a periodic back and forth movement at a regular speed. As used herein, the term “vibration” may refer to aperiodic or periodic back and forth movement at irregular speeds and variable frequencies. An oscillation is a special case of a vibration, and the term “vibration” is meant to include back and forth movements, which may include periodic oscillations.

The cut of oil and water within the fluid flow may produce a variable dielectric constant, which may be determined from signal changes with respect to one or more of the sensors. Further, as the fluid mixture moves from the inlet chamber to the outlet chamber through the chamber, the effective cross-sectional area of the fluid flow path changes, providing a Venturi effect. Moreover, the cross-sectional area of the outlet chamber varies with the position of the movable element, providing a variable Venturi effect. The differential fluid pressure and thus the flow rate may be determined based on one or more of the position of the check disk or the pressure data.

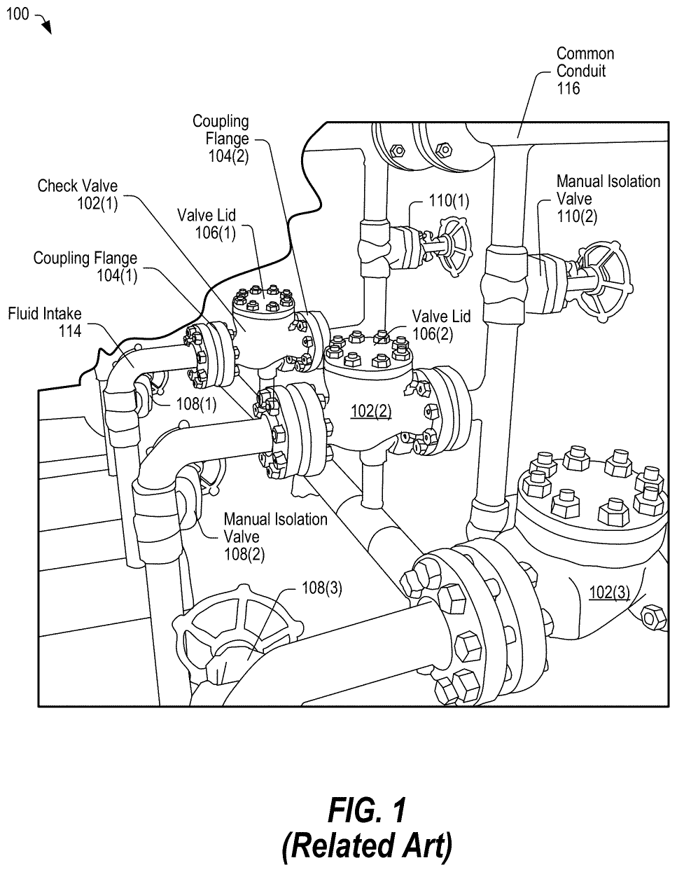

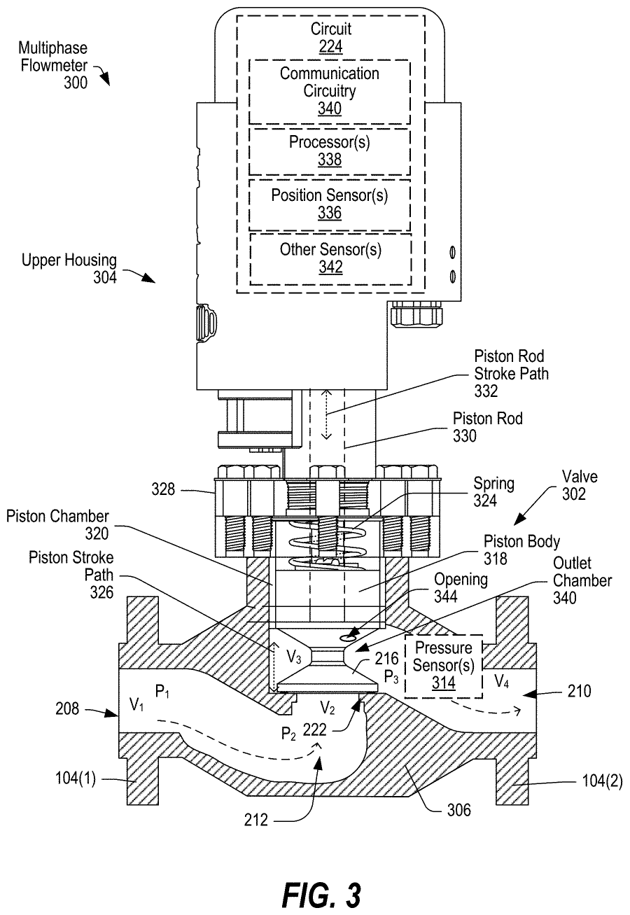

The multiphase flowmeter of the present disclosure was designed for use in a crude oil production environment, which exposes the flowmeter to a fluid mixture that may include water, oil, entrained gas, and debris. However, the multiphase measurement and flow rate measurement functionality may be used in other environments that have a fluid mixture, such as industrial process control environments, and so on. In the crude oil production environment, most production wells include multiple check valves near the well head. Embodiments of the flowmeter, described below beginning with FIG. 3, may include a valve and may be used to replace conventional check valves to provide both check valve functionality and multiphase flowmeter functionality. To understand the crude oil production context in which the flowmeter may be used, a conventional check valve is described with respect to FIG. 1.

FIG. 1 depicts a system 100 including a plurality of check valves 102 coupled between fluid intake 114 (such as a conduit coupled to a wellhead or other source) and a common conduit 116. Conventionally, the check valve 102 may be a mechanical valve that opens in response to fluid pressure and that closes when the fluid pressure decreases. In response to the fluid pressure, the check valve 102 may open to allow the crude mixture to flow from the fluid intake 114 to the common conduit 116 and may close to prevent the produced crude mixture from flowing back into the well, thus providing a one-way functionality.

Each check valve 102 may include a pair of coupling flanges 104 including a first coupling flange 104(1) coupled to a corresponding flange of the fluid intake 114 and including a second coupling flange 104(2) coupled to a corresponding flange of a pipe coupled to the common conduit 116. Each of the fluid intakes 114 may be coupled to a fluid source (such as a well head) to receive a fluid mixture, such as crude oil pumped out of an oil well, and an outlet of each check valve 102 may be coupled to a pipe (or conduit) that is connected to the common conduit 116.

In some embodiments, each of the pipes between the check valve 102 and the common conduit 116 may include a manual isolation valve 110, which can be accessed by an operator to isolate a check valve 102 from the common conduit 116. Further, each fluid intake 114 may include a manual isolation valve 108 that can be accessed by an operator to isolate the check valve 102 from the fluid source.

Each check valve 102 may include a valve lid or cover 106, which may be bolted or otherwise secured to the housing of the check valve 102. The cover 106 may be unbolted and removed to allow access to the check disk for servicing the valve 102. Conventionally, check valves 102 may require frequent servicing, in part, because the pressure and debris from the fluid mixture may cause the check disk to become stuck so that the check valve 102 fails. In one example, the check valves 102 may become stuck due to debris from the fluid mixture becoming lodged between the check disk and the housing. In another example, the check disk may become stuck (or worn over time) due to fluid pressure from the fluid mixture pushing the check disk against the housing within a fluid chamber of the check valve 102 or due to debris within the fluid flow causing the check disk to wear.

Conventionally, to determine a fluid flow rate, production may be turned off using the manual isolation valves 108 to temporarily halt production, and a specialized measurement system may be coupled to the common conduit and used to separate the fluid mixture into its single-phase components before determining the cut of oil, water, or gas in the fluid mixture. Such specialized measurement systems may be very expensive, costing $150,000 or more, and may only determine measurement data within a narrow range of pressures or flow rates. Moreover, such systems may operate for a limited time before requiring servicing. Such measurement systems are often connected for a brief period, such as a few days, and then the measurement system may be removed for servicing before connecting it to a different conduit. The flow information for the set of flow lines may then be estimated based on an assumption that the flow rate and the cut does not vary significantly between measurement cycles (e.g., until the measurement unit is reconnected to capture new samples).

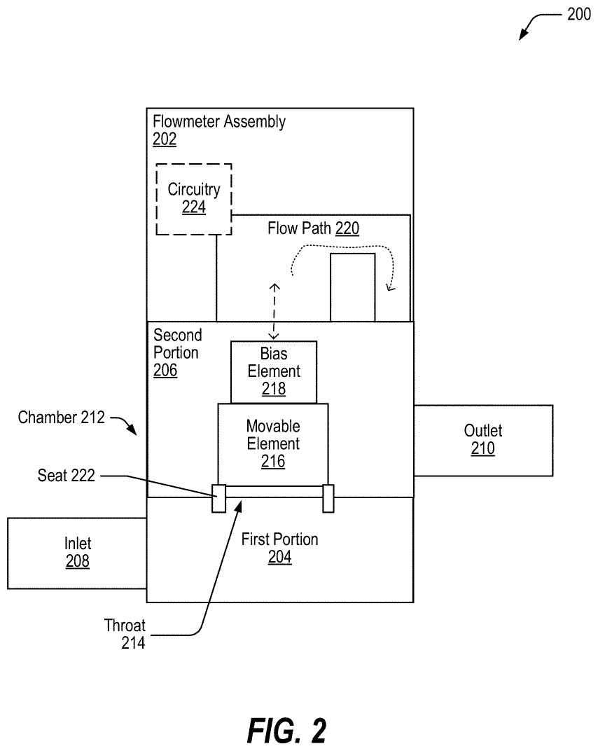

Embodiments of a multiphase flowmeter are described below that may take advantage of the internal geometry of the fluid flow path to determine the cut of oil, water, and gas in a fluid mixture. An example of a multiphase flowmeter is described below with respect to FIG. 2.

FIG. 2 depicts a block diagram of a multiphase flowmeter 200, in accordance with certain embodiments of the present disclosure. The flowmeter 200 may include a flowmeter assembly 202, which may include a fluid chamber 212 including a first portion 204 and a second portion 206. The flowmeter assembly 202 may include an inlet 208 coupled to the first portion 204 and an outlet 210 coupled to the second portion 206 of the chamber 212.

The flowmeter assembly 202 may include a movable element 216 within the second portion 206. The movable element 216 may be biased by a bias element 218 (such as a spring or other component) toward a seat 222, which may define a throat (or neck) 214 between the first portion 204 and the second portion 206.

The flow meter assembly 202 may include a flow path 220, which may extend into the housing and which may include a return path that returns the fluid to the second portion 206. The flowmeter assembly 202 may include circuitry 224, which may include one or more sensors to determine a position of the movable element 216, one or more pressure sensors, other sensors, or any combination thereof. Additionally, the circuitry 224 may include a processor configured to determine the flow rate and the cut of the different phases within the fluid mixture based on the position of the movable element 216, pressure data, other data, or any combination thereof.

The movable element 216 may be implemented in a variety of different form factors and may be configured to move linearly or along an acuate path, depending on the implementation. The bias element 218 may include a spring, a weight or other element that may operate to bias the movable element 216 toward the seat 222. In some implementations, the bias element 218 may define a pressure threshold and may hold the movable element 216 against the seat 222 until the fluid pressure exceeds the pressure threshold.

In operation, the fluid mixture may flow through the inlet 208 into the first portion 204 of the chamber 212. The fluid mixture may push the movable element 216 away from the seat 222 and the fluid mixture may flow through the throat 214 and into the second portion 206. A portion of the fluid mixture (including, for example, gas released from the fluid mixture) may flow through the flow path 220 within the flowmeter assembly 202 and back to the second portion 206 and the fluid mixture may flow through the outlet 210. In this example, the volume of the chamber 212 may be greater than that of the inlet 208 and the outlet 210. The chamber 212 may provide a pressure drop, enabling release of the entrained gas, which released gas may cause the movable element 216 to vibrate rapidly. Changes to the position of the movable element 216 over time may be used to determine the volume of the gas. Pressure data, movement data, and other data may be used to determine the cut of oil, gas, and water within the fluid mixture without separating the fluid mixture into its single-phase components.

In the following discussion, a multiphase flowmeter is disclosed that may be implemented as a check valve, which may be configured to modify or replace existing check valves to provide the valve functionality and to provide real-time measurements of flowrate and cuts of gas, liquid, and oil. The valve assembly may be configured to communicate measurement data or the flow rate and cuts of the gas, liquid, and oil to a control system through a communications link, which may be a wired connection or a wireless communication link. An example of the valve assembly is described below with respect to FIG. 3 that is configured to provide check valve functionality and flow rate and multiphase measurement functionality.

FIG. 3 depicts a diagram of a multiphase flowmeter 300, in partial cross-section, including a check disk to provide valve functionality and circuitry to determine multiphase measurements of a fluid mixture flowing through the valve, in accordance with certain embodiments of the present disclosure. The multiphase flowmeter 300 may be an implementation of the flowmeter 200 of FIG. 2. The multiphase flowmeter 300 may include a valve 302 and an upper housing 304, which may be configured to secure a circuit 224.

The valve 302 may include a valve body 306, which may include a fluid inlet 208, a fluid outlet 210, and a chamber 212 between the inlet 208 and the outlet 210. The valve 302 may include one or more pressure sensors 314. In this example, the pressure sensors 314 are shown in the chamber 212 on the outlet side of the valve 302. However, the pressure sensors 314 are depicted in phantom because they may be located in the inlet 208, the outlet 210, the chamber 212, or on both sides of the seat 222. In the illustrated example, the location of the pressure sensor 314 in the outlet chamber 340.

The position of the pressure sensor 314 in the outlet chamber 340 may provide several advantages. First, the outlet chamber 340 is above the inlet 208 and above the fluid flow path so that any portion of the fluid mixture that may be forced past a seal of the pressure sensor 314 may drain back into the outlet chamber 340 by force of gravity as opposed to being trapped at an elevation that is below the outlet chamber 340. Second, having the pressure sensor 314 above the outlet chamber 340 (above the conduit) makes it easier for a technician to access the sensor for service. Additionally, the outlet chamber 340 is closer to the upper housing 304 so that the electrical interconnections are shorter and simpler. The movable element 216 (implemented as a check disk in this implementation) enables a variable Venturi functionality because the position of the movable element 216 within the chamber 212 (and into a portion of the fluid flow path 220 that extends into the upper housing of the flowmeter assembly 202) may alter the volume of the second portion 206 of the chamber 212. Since the movable element 216 moves in response to fluid pressure, the volume of the chamber 212 may vary with the fluid pressure, enabling a variable Venturi that allows for flow measurements across a range of fluid pressures as a function of position data and pressure data. Another advantage is realized in that a traditional Venturi meter may require installation on a straight conduit with no connections or misalignments that might introduce turbulence into the flow while the variable Venturi provided by the valve 302 works in spite of turbulence in the fluid mixture.

The valve 302 may include a movable element 216, which may be configured as a check disk that may move up and down to open and close the valve 302 in response to fluid pressure. In some implementations, the movable element 216 may be coupled to a piston body 318. The movable element 216 and the piston body 318 may move linearly within a piston chamber 320, which extends from the outlet chamber 340 into the upper housing 304. The movable element 216 (and the piston body 318) moves along a piston stroke path 326 to open and close the valve 302. In a closed state, the movable element 216 may be pressed against a seat 222 by a spring force applied by spring 324 and by gravity. In response to fluid pressure, the movable element 216 may move away from the seat 222, opening to allow fluid flow from the inlet 208 through the chamber 212 to the outlet 210.

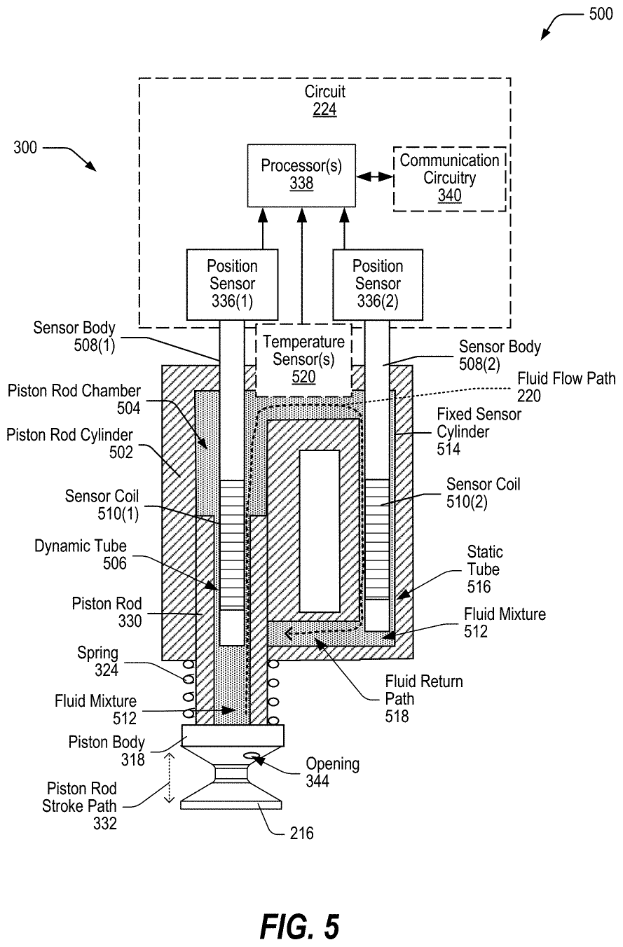

In some implementations, the piston body 318 may be coupled to a piston rod 330, which may be coupled to one or more of the movable element 216 or the piston body 318. The piston rod 330 may be formed from stainless steel or from another rigid material, which may be resistant to bending stresses. The piston rod 330 may extend into a cylindrical reinforcement sleeve or piston rod chamber (piston rod chamber 504 in FIG. 5) that extends from within the housing of the valve 302 adjacent to the outlet chamber 340 into the upper housing 304. The piston rod 330 may reinforce the piston body 318 and the movable element 216 by extending the effective length of the piston body 318. Lateral stresses that are applied to the movable element 216 and the piston body 318 by the fluid mixture are distributed across the length of the piston rod 330. The piston rod 330 and the piston rod cylinder 504 in FIG. 5 cooperate to maintain the movement of the movable element 216 along a linear path to prevent the fluid pressure from pushing the movable element 216 laterally, which might cause failure of the valve 302 due to deformation or sticking. In general, the piston chamber 320 may be larger in diameter than the piston body 318, which allows the piston body 318 to move up and down within the piston chamber 320. During operation, the piston body 318 and the movable element 216 may experience some small amount of lateral movement due to fluid pressure. Such lateral movement can cause debris to become trapped between the movable element 216 and the valve seat 322, between the movable element 316 or the piston body 318 and the sidewall of the piston chamber 320, or any combination thereof, causing the movable element 218 to become stuck (open or closed). The piston rod 330 assists the piston body to keep the movable element 216 in alignment with the valve seat 322 and to maintain the piston rod stroke path 332 as a linear path. In particular, the piston rod 330 limits the lateral movement of the piston body 318 and the movable element 216, preventing the movable element 216 from sticking due to debris and fluid pressure.

In the illustrated example, the piston body 318 may include a fluid opening 344, which may allow a portion of the fluid mixture to flow into a fluid flow path within the upper housing 304 and back to the outlet chamber 340. The opening 344 may extend into the piston chamber 326 and into the upper housing 304. The upper housing 304 may include a fluid flow path 220 (and shown in FIG. 5) that allows the portion of the fluid mixture to flow through a piston rod cylinder (502 in FIG. 5) and through a dynamic tube that extends within the piston rod 330 and then through a static tube and back to the piston rod cylinder to drain back into the outlet chamber 340. By allowing a portion of the fluid mixture to flow through the fluid path in the upper housing 304, the pressure equalization prevents hydraulic pistoning. Further, the circuitry 224 may interact with a portion of the fluid mixture to compensate for temperature and other parameters, such as by determining the temperature using the one or more other sensors 342 and by using the temperature to compensate for temperature drift in the measurement data. Further, in some implementations, changes in the fluid composition may alter the dielectric of the fluid, which can be determined based on signal changes with respect to one or more of the position sensors 336, the pressure sensors 314, or the other sensors 342.

The circuit 224 may include communication circuitry 340, which may include one or more input/output (I/O) interfaces that may couple to sensors and other circuit components. The I/O interfaces may include one or more connection ports that may be accessed to couple the circuit 224 to a computing device. The communication circuitry 340 may also include network interfaces, which may include one or more transceivers that may send data and receive data or processor-readable instructions through a wired or wireless (radio frequency) communications link to a control system or a computing device.

The circuit 224 may include one or more processors 338, which may receive sensor data and execute processor-readable instructions. The processor-readable instructions may be stored in a non-volatile memory, which may be part of the circuit 224. The processor 338 may also store measurement data, data determined from the measurement data, or any combination thereof in the memory.

The circuit 224 may also include, or may be coupled to, one or more pressure sensors 314, one or more position sensors 336, and one or more other sensors 342. The one or more pressure sensors 314 may be configured to generate signals indicative of a pressure of the fluid mixture within the valve 302 of the multiphase flowmeter 200. The one or more position sensors 336 may be configured to generate signals indicative of a position of the movable element 216 within the valve 302. The one or more other sensors 342 may include temperature sensors, salinity sensors, capacitive sensors, spectrometers, chemical sensors, other sensors, or any combination thereof.

In some implementations, the one or more position sensors 336 may include a body portion that may be stationary and that may extend into the dynamic tube that extends through the piston rod 330. The position sensor 336 may generate an electrical signal indicative of the position of the piston rod 330 relative to the position sensor 336. Since the movement of the piston rod 330 corresponds to the movement of the movable element 216, the sensed position of the piston rod 330 is indicative of the position of the movable element 216. In an example, as the movable element 216 moves upward, the piston rod 330 also moves upward by the same distance. When the movable element 216 moves downward, the piston rod 330 also moves downward by the same distance. By monitoring changes in the relative position of the piston rod 330, the position of the movable element 216 can be readily determined.

In some implementations, the processor 338 may be configured to determine a flow rate of the fluid mixture as based on the position data from the position sensors 336 and the pressure data from the pressure sensor 314. The processor 338 may be configured to receive the position data associated with the movable element 216 and to determine a volume of gas within the fluid mixture based on changes in the position data over time. In still another example, the processor 338 may be configured to determine volumes of oil and water within the fluid mixture based on one or more of the pressure data, the position data, or data from other sensors. The processor 338 may communicate the determined data (flow rate, gas volume, cut of oil and water, and so on) to the control system.

In the illustrated example, the inlet 208 and the outlet 210 may have substantially identical cross-sectional areas. The chamber 212, which may include a first portion 204 and a second portion 206 (or output chamber 340), may have a cross-sectional area that is larger than the inlet 208 or the outlet 210. Further, the cross-sectional area of the valve seat 222 may be narrower than the chamber 212 (or optionally narrower than the inlet 208 or the outlet 210). The chamber 212 may provide an expansion area, which may encourage the entrained gas to separate from the fluid mixture, causing the movable element 216 to vibrate rapidly (at a relatively high frequency) in brief bursts, while the variations in the position of the movable element 216 relative to the liquid/oil portion of the fluid mixture may cause the movable element 216 to move more slowly (at a relative low frequency).

During operation, the movable element 216 and the piston body 318 may move within the outlet chamber 340, providing a reduced cross-sectional area that varies over time as the movable element 216 moves. When fully open, a portion of the piston body 318 and a portion of the movable element 216 may be recessed into the piston chamber 320, but a portion of the movable element 216 may still extend within the outlet chamber 340. Thus, the movable element 216 and the body portion 318 may vary the cross-sectional area (and volume) of the outlet chamber 340 based on the position of the movable element 216. This variable cross-sectional area provides a variable Venturi effect, which can be used to determine the flow rate of the fluid mixture at a wide range of flow rates and pressures.

In an example, a pump jack may have a pump cycle or period of six seconds in which each stroke includes a three second portion in which the fluid mixture is actively pumped through the flowmeter 300 and a three second portion as the pump jack resets. The multiphase flowmeter 300 may determine flow rates for a fluid mixture in which the flow volume and pressures vary with the operation of the pump jack. In this example, the flowmeter 300 may experience a fluid pressure swing between less than 10 pounds per square inch (PSI) and to more than 850 PSI over a period of less than three seconds and then may experience a decrease in the fluid pressure from over 850 PSI to 10 PSI over a similar period. This change in pressure may be repeated with each cycle of the pump jack, e.g., every six seconds. The flow rate of the fluid mixture through the multiphase flowmeter 300 also varies from a very high flow volume to a very low flow volume as the fluid pressure varies. The variable Venturi effect provided by the movable element 216 may allow the flowmeter 200 to measure the fluid flow rate across the entire spectrum of the pump jack cycle.

Conventional Venturi sensors may struggle to measure the flow rate of the fluid mixture with such wide variations because such sensors are typically tuned for accurate measurement within a narrow range (such as a range of flow rates that vary within a ratio of 2 to 1 (e.g., 400 Gallons per Minute (GPM) to 200 GPM). In contrast, the variable Venturi functionality provided by the movable element 216 of the flowmeter 300 may be used to provide flow rate measurements for fluid flows ranging from a low flow rate or trickle to a high flow rate. In one non-limiting example, the flowmeter 300 may measure fluid flow rates for a fluid mixture that has a variable flow that ranges from tens of barrels per day to tens of thousands barrels per day (1:10,000 ratio). The range of variability may depend, in part, on the implementation including the diameter of the conduits. The range of the Venturi functionality provided by the flowmeter 300 may be configurable to measure variable fluid flows, such as those produced by a pump jack in the crude oil production industry, across any selected range of fluid flows, bounded only by the limits of the production environment. For example, the flowmeter 300 may be configured to measure fluid flow rates across a range of fluid flows that may vary from low to high by a factor of 1000 or more, which range is not supported by conventional Venturi devices.

In one implementation, one or more pressure sensors 314 may be provided in the outlet chamber 340 within which the movable element 216 moves. The processor 338 of the circuit 224 may receive pressure data from the pressure sensor 314 and may receive position data corresponding to a position of the movable element 216 from the position sensors 336. The processor 338 may be configured to determine a flow rate of the fluid mixture based on the pressure data and the position data. In some implementations, the amplitude of the pressure may be determined based on the position data.

In addition to determining the flow rate, the processor 338 may be configured to determine other parameters of the fluid mixture, such as a volume of gas within the fluid mixture, based on the change in position of the movable element 216 over time. In some implementations, the processor 338 may determine the volume of gas within the fluid mixture based on vibrations (or oscillations) of the movable element 216, which may be determined based on signals from the position sensors 336.

In some implementations, the vertical flow of the fluid mixture through the valve seat 222, the change in pressure due to expansion of the fluid mixture into the chamber 212, the turbulence due to the change in direction (horizontal to vertical and back to horizontal) of the fluid path, or any combination thereof may cause the entrained gas to separate from the fluid mixture and expand into the inlet chamber 212 and through the seat 222. The release of the entrained gas may introduce vibrations (or oscillations) in position of the movable element 216.

In some implementations, the fluid mixture may push the movable element 216 open sufficiently to allow the entrained volume of the fluid mixture (oil, water (or other entrained liquid), and any remaining entrained gas) to pass through the valve seat 222 and into the outlet chamber 340. The released, expanded gas may build up in the chamber 212 until it reaches a pressure that is greater than the threshold pressure. Since gas moves faster than the remaining fluid mixture, once the gas pressure is sufficient to move the movable element 216 independently of the remaining fluid mixture, the gas may force its way through the valve seat 222 in a “packet” or “accumulated mass”, pushing the movable element 216 very rapidly and causing the movable element 216 to vibrate (oscillate rapidly back and forth along the piston stroke path 326).

The vibrational frequency (or oscillating frequency) of the movable element 216 may be significantly different when the movement is caused by the gas packets as compared to the liquid and oil portion of the fluid mixture. The processor 338 may determine the volume of gas within the fluid mixture based on the frequency of the vibrations (or oscillations) determined from the changes in the position data.

In some implementations, the processor 338 may be configured to determine one or more other parameters of the fluid mixture, such as a volume of oil, or a volume of liquid within the fluid mixture based on one or more of the position measurement data, the pressure measurement data, an electrical parameter associated with one or more of the sensors, other sensor data, or any combination thereof. In an example where the liquid portion of the fluid mixture has a substantially constant chemical composition, the cut of oil versus liquid may be determined as a function of changes in the dielectric constant of the fluid, which may be determined based on electrical signals from the one or more position sensors 336. For example, water may have a dielectric constant of approximately 80.4 at a temperature of 20 degrees Celsius, while oil may have a dielectric constant of approximately 2.1 to 2.4, depending on various aspects of the makeup of the oil mixture. A fluid mixture comprised of oil and water would have a dielectric constant that would fall somewhere between 80.4 and 2.1, and the effective dielectric constant may provide a reliable measurement of the cut of water versus oil in the fluid mixture.

In some implementations, the salinity of the water may alter the dielectric constant. Some studies have shown that, at 20 degrees Celsius, the dielectric of a saltwater solution may vary between approximately 80 and 45 depending on the salt concentration. As the salt concentration increases, the electrical permittivity of the solution decreases. In some implementations, the other sensors 342 of the flowmeter 300 may include one or more salinity sensors to determine the salt content of the fluid mixture so that the dielectric of the liquid component may be determined. Based on this information, the change in the dielectric constant of the fluid mixture may provide a reliable measurement of the cut of water versus oil in the fluid mixture.

In some implementations, the other sensors 342 may include a capacitive sensor, which may be used to determine the dielectric constant of the fluid mixture. In some implementations, the position sensors 336 may experience the dielectric changes and the dielectric may be determined from the changes in the electrical signals of the position sensors 336. Other implementations are also possible.

In other implementations, the other sensors 342 may include a spectrometer that may be configured to irradiate the fluid mixture and to determine the chemical content of the fluid mixture based on the reflected data. In other implementations, the other sensors 342 may include chemical sensors, each of which may be configured to measure for the presence of a specific chemical within the fluid mixture. Other implementations are also possible.

Conventionally, the cut of oil and water of a selected well is measured using a device that is coupled to the output of the well for a period of time to sample the well's production. Once the measurement is taken, the device is typically decoupled from the well to be used to test other wells. It is assumed that the cut of oil and water remains substantially constant for a selected well over a period of time, so the cut of the well is estimated for the period of time until the selected well's production is measured again. The flowmeter 300 may determine the various components of the fluid composition in real time, making it possible to better understand the production of crude oil.

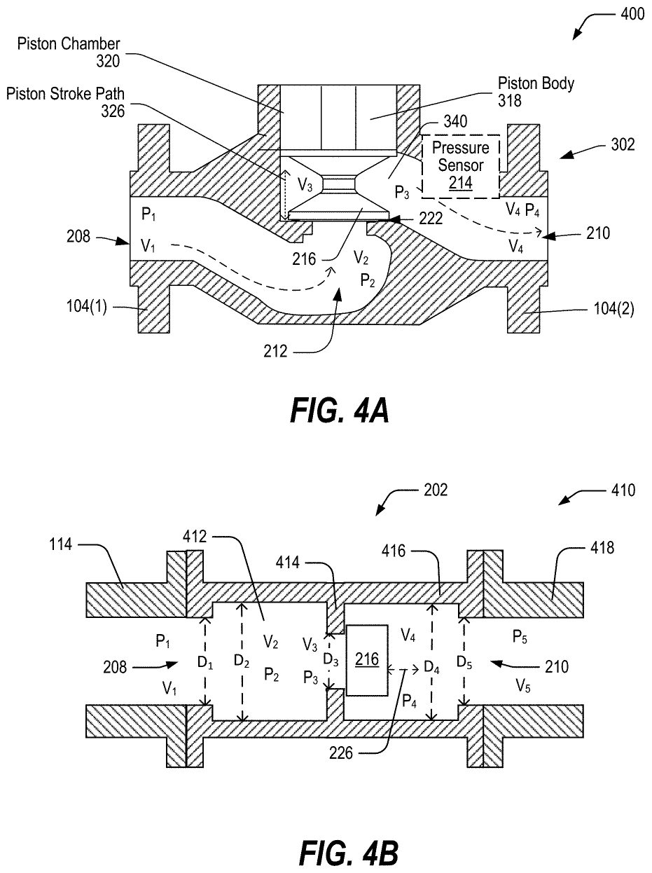

FIG. 4A depicts a portion 400 of the flowmeter 300 of FIG. 3, including the valve 302, in accordance with certain embodiments of the present disclosure. The valve 302 includes all the elements described above with respect to FIG. 3. In this example, the upper housing 304 is omitted for ease of discussion.

As the fluid mixture flows from the conduit 114 and through the inlet 208, the pressure of the fluid mixture may remain substantially constant because the cross-sectional area of the inlet 208 may substantially match the cross-sectional area of the conduit 114 (within margins of error for manufacturing tolerances). As the fluid mixture moves into the chamber 212, the cross-sectional area may change. In some implementations, the cross-sectional area may be reduced, increasing the fluid pressure. In other implementations, the cross-sectional area may be expanded, reducing the fluid pressure and releasing the entrained gas.

In the illustrated example, the chamber 212 has a cross-sectional diameter (D₂ in FIG. 4B) that is greater than the cross-sectional area of the conduit 114 and the inlet 208. The chamber 212 represents an expansion chamber, which may encourage the entrained gas to separate from the fluid mixture. The decrease in pressure may cause the entrained gas to expand and release from the fluid mixture.

Further, the chamber 212 defines a flow path that causes the fluid mixture to change direction through the throat 214 and through the seat 222. The turn or change of direction of the fluid flow path may introduce turbulence, which may disrupt the homogeneity of the fluid mixture, facilitating the separation of the entrained gas from the fluid mixture. In some implementations, the turbulence may cause some of the entrained gas to separate from the fluid mixture.

As the fluid mixture (gas, oil, and water) flows through the opening in the seat 222, the cross-sectional area of the seat 222 is less than that of the chamber 212, so the fluid mixture is forced through a narrowing element and into the outlet chamber 340. The outlet chamber 340 may have the same cross-sectional area as the chamber 212 when the presence of the movable element 216 is neglected. However, the volume of the movable element 216 reduces the effective volume of the outlet chamber 340. In a closed position, entire movable element 216 may be within the outlet chamber 340. In a fully open position, the piston body 318 and a portion of the movable element 216 may recede into the piston chamber 320 and a portion of the movable element 216 may remain in the outlet chamber 340. Thus, the volume of the outlet chamber 340 (whether the movable element 216 is in a fully closed position, a fully open position, or any position in between) may be less than the volume of the chamber 212, and the cross-sectional area of the fluid flow path from the seat 222 through the outlet chamber 340 may vary with the position of the movable element 216. The difference in the cross-sectional areas between the chamber 212 and the combination of the valve seat 222, the outlet chamber 340, and the movable element 216 may provide a variable cross-sectional area that can produce a variable Venturi functionality that enables fluid flow rate measurements across a wide range of flow rates and a wide range of pressures. In an example, the flowmeter 300 may determine fluid flow rates at low flow rates and low pressures (such as less than 10 PSI) to high flow rates and high pressures (such as 10,000 PSI or more). In some implementations, the variable Venturi functionality of the flowmeter 300 may enable flow rate measurements at pressures ranging from 10 PSI or less to pressures of 15,000 PSI or more.

FIG. 4B depicts a Venturi tube model 410 of the valve 302 of FIGS. 3 and 4A. In this example, the model 410 includes an inlet 208 having a first cross-sectional diameter D₁ that is substantially the same as the diameter of the conduit 114. The fluid mixture has a first flow rate (or velocity V₁) as it passes through the inlet 208. The first flow rate is substantially the same as the flow rate of the fluid mixture within the conduit 114. The fluid mixture has a first pressure P₁ at the inlet 208.

The model 410 includes a chamber 412 (which represents the chamber 212 of the valve 202) that has a second cross-sectional diameter D₂ that is larger than the first cross-sectional diameter D₁ of the inlet 208. The fluid mixture experiences a second pressure P₂ that is less than the fluid pressure P₁ as the fluid mixture moves through the chamber 412. As the pressure decreases, the flow rate (second velocity V₂) of the fluid mixture increases relative to the first velocity V₁.

The model 410 includes a narrowing element 414 between the inlet chamber 412 and the outlet chamber 416. The narrowing element 414 may represent the seat 222 or throat 214 of the valve 302, and the outlet chamber 416 may represent the outlet chamber 340 of the valve 302. The narrowing element 414 may have a cross-sectional diameter D₃ that is less than the cross-sectional diameter D₂ of the chamber 412. As the fluid mixture passes through the narrowing element 414, the velocity V₃ of the fluid mixture increases.

The model 410 includes the outlet chamber 416, which has a cross-sectional diameter D₄ that is approximately the same as the cross-sectional diameter D₂ of the inlet chamber 414. However, the volume of the movable element 216 is within the outlet chamber 416 and alters the cross-sectional area as it moves. In the illustrated example, the recess is not shown into which the movable element 216 moves, but should be understood from the illustrated example in FIG. 4A. The fluid mixture within the outlet chamber 416 may have a fourth pressure P₄ and a fourth velocity V₄, which may vary as the cross-sectional diameter D₄ changes with movement of the movable element 216.

The model 410 also includes an outlet 210, which may be coupled to a conduit 418, which may be coupled to the common conduit 116. The outlet 210 may have a fifth cross-sectional diameter D₅, which may be approximately equal to the first cross-sectional diameter D₁ of the inlet 208 and to the cross-sectional diameter of the conduit 418.

In operation, the valve 302 may provide a variable Venturi effect as the movable element 216 moves, changing the effective cross-sectional diameter D₄ of the outlet chamber 416. As the fluid mixture moves from the inlet chamber 414 into the smaller diameter (D₂) orifice of the narrowing element 414, the velocity of the fluid mixture increases to enable mass flow through the valve 302. The increased velocity produces a pressure differential. The highest velocity is at a point of the lowest pressure (smallest cross-section). As the fluid mixture passes the point of the greatest restriction, the velocity reaches a maximum and its pressure falls to a minimum, so the highest velocity is expected at the narrowing element 414 or seat 222. As the pressure decreases, the entrained gas may expand and separate from the fluid mixture, and packets of released gas may cause the movable element 216 to vibrate rapidly. The relatively high frequency vibrations (or oscillations) of the movable element 216 may be used to determine a volume of gas within the fluid mixture.

FIG. 5 depicts a partial block diagram and partial cross-sectional diagram 500 of a multiphase flowmeter 300 including a pair of position sensors 336 that may be used to determine a position of the movable element 216, in accordance with certain embodiments of the present disclosure. In this example, the movable element 216 is shown coupled to a piston body 318, which is coupled to the piston rod 330. The piston body 318 and the piston rod 330 are biased by the spring 324, which pushes the movable element 316 toward the seat 222.

The piston rod 330 may extend into a piston rod chamber 504 within a piston rod cylinder 502. The piston rod chamber 504 may allow the piston rod 330 to move up and down and may restrain the piston rod 330 from lateral movement, reinforcing the movable element 216 and the piston body 318 to prevent the high pressure of the fluid mixture from moving the movable element 216 out of alignment so that the movable element 216 moves linearly along the piston rod stroke path 332.

In this example, the piston rod 330 may include a lumen that functions as a dynamic tube 506. A first position sensor 336(1) may include a sensor body 508(1) including a sensor coil (or wire traces) 510(1). The sensor body 508(1) may be arranged to extend into the dynamic tube 506. As the movable element 216 moves, the piston rod 330 moves, and the position sensor 336(1) produces electrical signals indicative of the position of the piston rod 330.

In this example, the multiphase flowmeter 500 may include a second position sensor 336(2) including a sensor body 508(2) with a sensor coil 510(2). The sensor body 508(2) may extend into a static tube 516 within a fixed sensor cylinder such that the second position sensor 336(2) may present a static position signal that can be used to determine position data from the signals from the first position sensor 336(1). In a preferred implementation, the diameters of the dynamic tube 506 and the static tube 516 should be substantially the same (within margins of error due to manufacturing tolerances).

In some instances, the position sensors 336(1) and 336(2) may have measurement variations due to manufacturing variations, which may be calibrated during manufacturing or assembly. Temperature may cause errors in the measurement signals. To remove variations due to temperature, both sensors 336 may be exposed to the fluid mixture. The piston body 318 may include the opening 344, which may allow a portion of the fluid mixture to flow into the dynamic tube 506 and along a fluid flow path within the upper housing 304. The fluid mixture may flow through the dynamic tube 506 and into the static tube 516 and then back to the piston rod chamber 504 through a fluid return path 518. The fluid mixture exposes the sensor coils 510 of both position sensors 336 to the fluid mixture and thus to the same temperature environment. Additionally, one or more temperature sensors 520 may be coupled to the fluid path to determine a fluid temperature, which can be used to compensate the position data for temperature variations. Additionally, since both position sensors 336 are exposed to the same or similar vibrations in the production environment, signal variations caused by vibrations or other environmental conditions may cancel one another.

In some implementations, the flow information to be determined from movement of the fluid mixture through the flowmeter 300 may include several unknowns, including the flow rate, the fluid pressure, and the fluid contents. By measuring the pressure in the chamber 212 or the outlet chamber 340 and monitoring the position of the movable element 216, the flow rate may be determined. By monitoring vibrations in the movable element 216 (based on position data), the gas volume of the fluid mixture may be determined. By monitoring changes in the electrical signals from the position sensors 336, changes in capacitance or dielectric constant can be determined. By using one or more other sensors to determine parameters of the liquid components of the fluid mixture (such as salinity or specific chemical content (e.g., Mercury, lithium, or other chemicals or minerals)), the flowmeter 300 may be configured to determine a cut of water versus oil in the fluid mixture. Thus, the flowmeter 300 may be configured to determine flow rate and volumes of gas, oil, and water in the fluid mixture while providing a valve functionality to prevent back flow into the well.

The multiphase flowmeter 300 may present numerous advantages over conventional measurement systems. First, the flowmeter 300 may provide measurement data in real-time and for the entire operating cycle of the well, enabling accurate measurement data during operation and not just when the measurement device is periodically coupled to the well. Second, the flowmeter 300 remains in situ during operation, and does not require down time for connection and disconnection to be used on another conduit like the current measurement systems do. Third, the flowmeter 300 provides flow rate and multiphase information, which normally require multiple different measurement systems. Fourth, the flowmeter 300 does not require frequent recalibration, since the measurements are self-calibrating. Fifth, the flowmeter 300 provides immediate feedback in the event of valve failure because the sensor data would indicate that the movable element 216 is not moving. Sixth, the flowmeter 300 enables accurate information related to the gas volume, which is a requirement in some jurisdictions for environmental reporting. Other advantages may be apparent to those skilled in the art in light of the present disclosure.

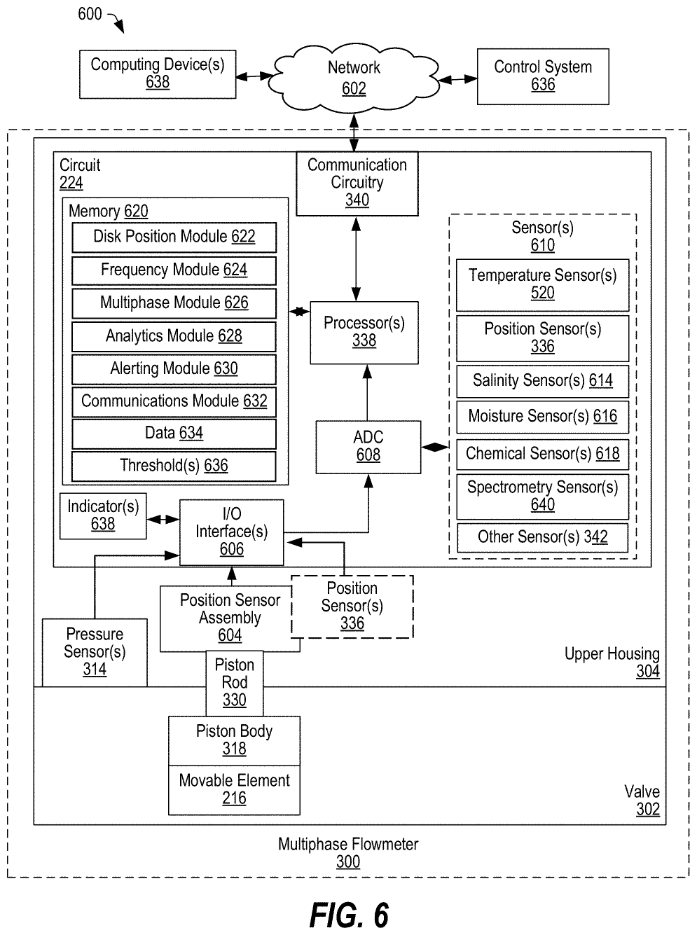

FIG. 6 depicts a block diagram of a system 600 including a flowmeter according to any of FIGS. 2-5, in accordance with certain embodiments of the present disclosure. The system 600 may include a control system 636 and one or more computing devices 638 that may communicate with the multiphase flowmeter 300 through a communications network 602, which may include the Internet, a cellular or digital communications network, a short-range wireless network, or a wired communications link.

The multiphase flowmeter 300 may include a valve 302 coupled to an upper housing 304. The valve 302 may include a movable element 216 coupled to a piston body 318, which may be coupled to a piston rod 330 that extends into the upper housing 304. In some implementations, the valve 302 may include one or more pressure sensors 314, which may extend into or may be coupled to the valve 302.

The upper housing 304 may be mechanically coupled to the valve 302 and may be electrically coupled to the one or more pressure sensors 314. The upper housing 304 may include at least a portion of the piston rod 330 coupled to a position sensor assembly 604, which may include one or more position sensors 336 to generate an electrical signal indicative of a position of the movable element 216 based on the position of the piston rod 330.

The upper housing 304 may include a circuit 224. The circuit 224 may include one or more input/output (I/O) interfaces 606, which may be coupled to the one or more pressure sensors 314 to receive signals indicative of the fluid pressure within the valve 302. The one or more I/O interfaces 606 may be coupled to the one or more position sensors 336 to receive signals indicative of the position of the movable element 216.

The circuit 224 may include an analog-to-digital converter (ADC) 608, which may convert the signals received from the pressure sensors 314 and the position sensors 336 into digital data. The circuit 224 may include one or more processors 338 coupled to the ADC 608. The processors 338 may include microcontroller units, field programmable gate arrays, general processors, other types of processors, or any combination thereof. The processors 338 may be configured to execute processor-readable instructions and to operate on data.

The circuit 224 may include one or more sensors 610 coupled to the ADC 608. The one or more sensors 610 may include one or more temperature sensors 612, one or more vibration sensors 614, one or more moisture sensors 616, and one or more other sensors 618. In some implementations, the one or more sensors 610 may be used by the processor 338 to account for noise in measurements data and optionally to detect issues with the flowmeter 300. For example, in some implementations, the moisture sensors 616 may be configured to detect leaks in the upper housing 304 that may expose the circuit 334 to moisture. Alternatively, the processor 338 may determine a stuck valve based on the position data, such as when the position data does not change over a period of time. Other implementations are also possible.

The circuit 224 may include a memory 620, which may store data 634 and one or more modules that may be executed by the processor 338. The memory 620 may be a non-volatile memory, which may be implemented as a flash memory, a hard disc drive, or another non-volatile memory device.

The memory 620 may include a disk position module 622 that may cause the processor 338 to determine the position of the check disk 620 from the position data received from the one or more position sensors 336. The position of the movable element 216 may vary over time as the fluid mixture flows through the valve 302.

The memory 620 may include a frequency module 624 that may cause the processor 338 to determine one or more frequency components within position data from the position sensors 336. The frequency components may be determined from the frequency of changes in the position of the movable element 216 over time. In some implementations, the frequency module 624 may cause the processor 338 to determine that the movable element 216 is stuck. In some implementations, the circuit 224 may include or may be coupled to one or more indicators 638, which may be controlled by signals from the processor 338 to provide an indication that the movable element 216 may be stuck and may require servicing. In some implementations, the indicator 638 may include a light-emitting diode to provide a visual indicator, a speaker to provide an audible indication, or another device to provide a detectable indicator to assist a user to identify a stuck valve.

The memory 620 may include a multiphase module 626 that may cause the processor 338 to determine the content of the fluid mixture (oil, gas, and water) based on one or more of the position data, the pressure data, changes in electrical signals determined from the sensors, sensor data from other sensors (such as a spectrometer, chemical sensors, salinity sensors, or other sensors), or any combination thereof In some implementations, the multiphase module 626 may cause the processor to compare vibration data (the frequency components of the position data) to one or more thresholds 636 to differentiate between gas and liquid phase components within the fluid mixture.

The memory 620 may include an analytics module 628 that, when executed, may cause the processor 338 to determine the dielectric of the fluid mixture based on changes in the electrical signals from the one or more position sensors 336. The analytics module 628 may also cause the processor to receive data from one or more salinity sensors 614, one or more moisture sensors 616, one or more chemical sensors 618, one or more spectrometry sensors 642, one or more other sensors 342, or any combination thereof. The analytics module 628 may be configured to determine the cut of oil versus water in the fluid mixture based one or more of the salinity data, the moisture data, the chemical data, the spectrometry data, or other data.

In some implementations, the analytics module 628 may cause the processor 338 to determine state information related to the operation of the valve 302. For example, in response to determining that the amplitude of the movement of the check disk 216 is less than a threshold amplitude for a period of time, the analytics module 628 may detect a stuck valve condition in which debris may have become lodged in the outlet chamber 340 in such a way as to prevent free movement of the check disk (either preventing the movable element 216 from closing or limiting the opening of the movable element 216). In another example, the analytics module 628 may detect changes in signal strength or noise in received signals that may be indicative of a connection issue or a circuit issue that may require service. In some implementations, the analytics module 628 may be configured to determine selected parameters associated with the fluid mixture or the multiphase flowmeter 300.

The memory 620 may include an alerting module 630 that, when executed, may cause the processor 338 to generate output data indicative of one or more of the flow rate, the gas volume, the liquid volume, the oil volume, or the state of the valve assembly (e.g., a stuck condition), or other data. The alerting module 630 may cause the processor 338 to send the information to a control system 636, one or more computing devices 638, or any combination thereof through network 602.

In some implementations, it may be assumed that the fluid mixture has a substantially homogenous flow rate for the fluid mixture. However, oil and water within the fluid mixture may have different flow patterns, and the pressure gradient of the fluid flow may be dependent on the flow pattern. For multiphase flowmeters 300 that are positioned adjacent to the well head, the fluid mixture may have a dispersed flow represented by a continuous phase of entrained water, oil, and gas, and the dispersion within the pipe cross-section may be homogenous for the purpose of measuring fluid pressure. However, as the fluid expands in the chamber 212 and as the fluid path turns as it passes through the flowmeter, turbulence may be introduced into the fluid mixture that, in combination with a drop in fluid pressure, may cause at least some of the entrained gas to separate from the fluid mixture. The turbulence may also cause the homogeneity of the fluid mixture to be disrupted, and this disruption may produce a separation that enables measurement of the gas and liquid components of the fluid mixture using one or more sensors, such as position data from the position sensors 336.

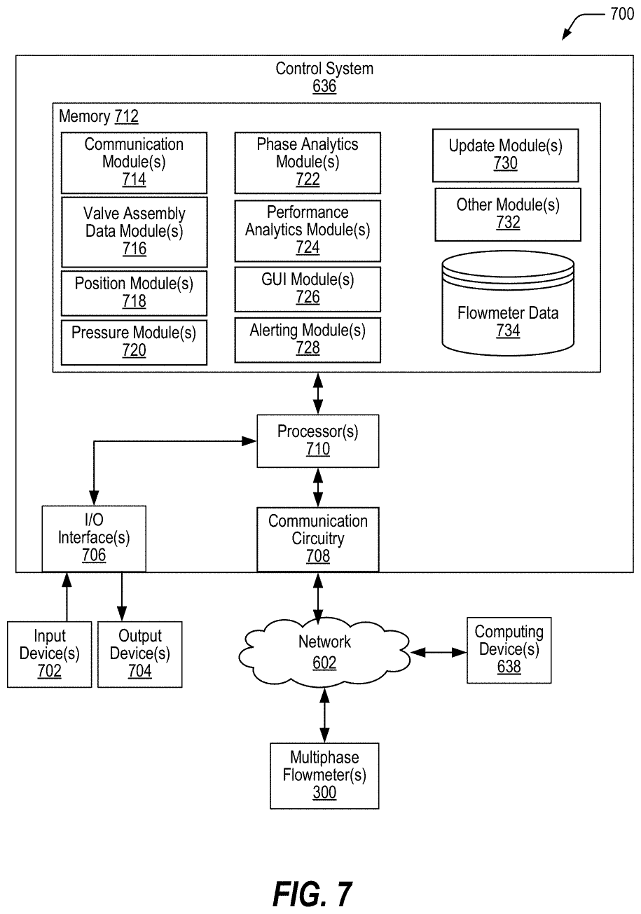

While the illustrated example of FIG. 6 depicted a circuit 224 configured to determine the cut of oil, gas, and water within a fluid mixture as well as the flow rate of the fluid mixture, in some implementations, the circuit 224 may send the measurement data to a control system 636, which may determine the flow rate and the cut (oil, gas, and water) based on the measurement data. An example of the control system 636, described below with respect to FIG. 7, may receive the flow rate and cut data or may receive the raw data and determine the flow rate and cut from the raw data.

FIG. 7 depicts a block diagram of a system 700 including a control system 636 coupled to one or more multiphase flowmeters 300, in accordance with certain embodiments of the present disclosure. The control system 636 may be coupled to one or more computing devices 638 through the network 602. The control system 636 may also be coupled to one or more multiphase flowmeters 300 through the network 602 (through wired or wireless connections). The control system 636 may be coupled to one or more input devices 702 (such as a keyboard, a touchscreen interface, a track pad, a pointer, a microphone, a scanner, another input device, or any combination thereof). The control system 636 may be coupled to one or more output devices 704, such as a display device, a speaker, a printer, or another output device.

The control system 636 may include one or more I/O interfaces 706, which may be configured to couple to the one or more input devices 702 and to the one or more output devices 704. The control system 636 may include communication circuitry 708, which may communicate data to and receive data from the network 602. In some implementations, the communication circuitry 708 may receive data from one or more sensor assemblies 202. The data received from the network 602 may include raw measurement data or may include flow rate, cut data, or any combination thereof from one or more of the multiphase flowmeters 300. The communication circuitry 708 may also communicate data to one or more computing devices 638 through the network 602.

The control system 636 may include one or more processors 710 coupled to the I/O interfaces 706 and to the communication circuitry 708. The control system 636 may also include a memory 712 configured to store data and to store processor-readable instructions. The memory 712 may be a non-volatile memory such as a flash drive, a hard disc drive, another non-volatile memory, or any combination thereof.

The memory 712 may include one or more communication modules 714 that may cause the processor 710 to receive data from one or more of the multiphase flowmeters 300, to send data and optionally software updates to the multiphase flowmeters 300, and to communicate data to and receive data from one or more computing devices 638 through the network 602.

The memory 712 may include one or more valve assembly data modules 716, which may receive and correlate data from one or more of a plurality of multiphase flowmeters 300. The data may be stored in a database, such as the flowmeter data 734. In some implementations, the flowmeter data 734 may be stored remotely and may be accessed through the network 602.

The memory 712 may include one or more position modules 718 that may cause the processor 710 to determine changes in the position of the movable element 216 for each of the multiphase flowmeters 300 based on the received data. The memory 712 may include one or more pressure modules 720 that may cause the processor 710 to determine pressure measurement data from the received data.

The memory 712 may include one or more phase analytics modules 722 that may cause the processor 710 to determine a flow rate of a fluid mixture flowing through a selected multiphase flowmeter 300 and to determine the cut of oil, gas, and water components within the fluid mixture based on one or more of the position data, the pressure measurement data, a dielectric constant, other data, or any combination thereof. The memory 712 may include one or more performance analytics modules 724 that may cause the processor 710 to determine performance data for one or more wells based on the determined flow rate and the determined cut from one or more multiphase flowmeters 300. In some implementations, the performance analytics module 724 may determine a change in production of a well based on changes in the flow rate or the cut and may generate data for presentation within a graphical interface or via an alert.

The memory 712 may include a graphical user interface (GUI) module 726 that may cause the processor 710 to generate a graphical interface, which may include data and one or more user-selectable controls. The processor 710 may provide the graphical interface to an output device 704, such as a display. Alternatively, the processor 710 may provide the graphical interface to a computing device 638 through the network 602. In some implementations, the graphical interface may include data reflecting production information, such as volume and cut data reflecting production of oil and gas from a well.

In some implementations, the performance analytics module 724 may determine an error event based on the position data, the pressure data, or any combination thereof. The error event may be indicative of a check disk (movable element 216) stuck in an open position, in a closed position, or in an intermediate state. The stuck movable element 216 may be detected based on lack of changes in the movement data over a period of time. In another example, the performance analytics module 724 may determine that the overall flow from the well is less than a threshold flow, which may trigger a fracking operation, a steaming operation, or another operation to stimulate well production. In some implementations, the performance analytics module 724 may determine one or more parameters, which may be indicative of production, problems, errors, or other information. The data determined by the performance analytics module 724 may be communicated to a user via the GUI modules 726 or via an alert (text, email, phone call, or other detectable alert) using one or more alerting modules 728. The one or more alerting modules 728 may generate a text, email, phone call, or other indicator to notify one or more users of an issue with respect to one of the multiphase flowmeters 300. In some implementations, the alert may include information identifying a multiphase flowmeter 300 requiring service or attention.

The memory 712 may include one or more update modules 730 that may cause the processor 710 to send updated software, firmware, or other processor-readable instructions to one or more of the multiphase flowmeters 300. In some implementations, the processor 710 may send replacement modules for detection of one or more parameters of interest with respect to operation of the multiphase flowmeter 300. In an example, algorithms used to determine the oil, water, and gas cut measurements may be updated. In another example, thresholds may be adjusted to differentiate between gas-related vibrations and other movements of the movable element 216. In another example, pressure gradients may be updated to provide an improved indication of the cut between water and oil. In another example, various modules may be updated to improve determination of changes in the dielectric of the fluid mixture or to adjust various other functions. Other updates and other information may also be provided to the multiphase flowmeters 300. The memory 712 may include one or more other modules 732 that may cause the processor 710 to perform other operations.

In some implementations, one or more of the various modules 714, 716, 718, 720, 722, 724, 726, 728, and 730 may be incorporated into a single application. In other implementations, the functionality of some of the modules may be combined, and other modules may be omitted.

In operation, the control system 636 may be configured to manage an oil field, which may include multiple wells and a plurality of multiphase flowmeters 300. Data from each of the multiphase flowmeters 300 may be received at the control system 636, and the control system 636 may determine one or more adjustments for operation of the oil field based on the received data. In an example, the performance analytics module 724 may cause the processor 710 to determine a production decline based on the flow rates and cut data from a subset of the multiphase flowmeters 300 and may provide data to an output device 704 or a computing device 638 that may be indicative of the production decline. The data may be provided via one or more of a graphical interface generated by the GUI module 726 or an alert sent by the alerting module 728. Other implementations are also possible.

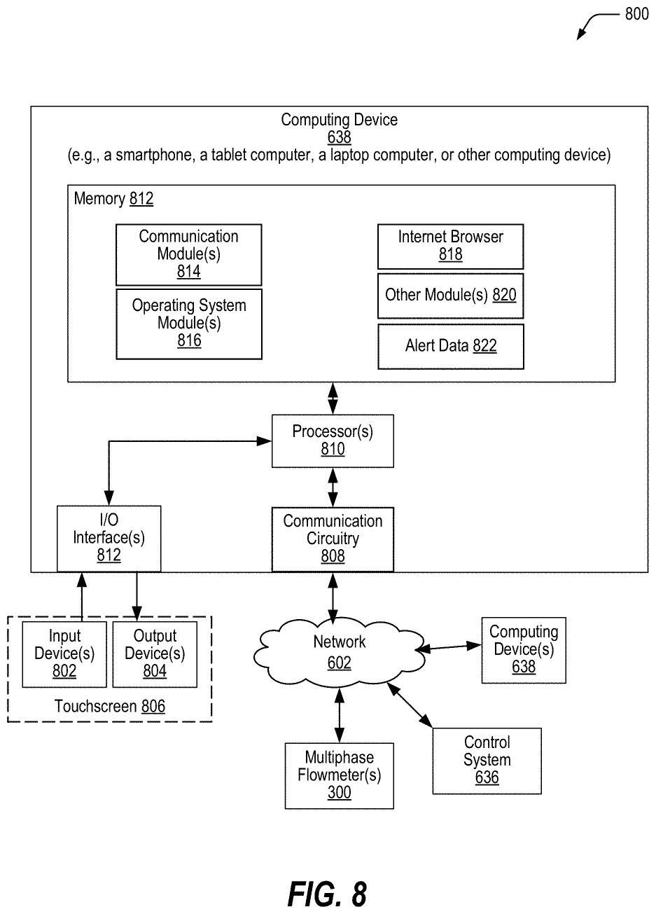

In some implementations, the control system 636 may send data (such as an alert or a graphical interface) to computing devices 638, such as smartphones, tablet computers, laptop computers, other computing devices, or any combination thereof. An example of a computing device 638 is described below with respect to FIG. 8.

FIG. 8 depicts a block diagram of a system 800 including a computing device 638 coupled to one or more of the multiphase flowmeter 300 of FIG. 6 or the control system 636 of FIGS. 6 and 7, in accordance with certain embodiments of the present disclosure. The computing device 638 may include a smartphone, a tablet computer, a laptop computer, or another computing device. The computing device 638 may be configured to communicate with one or more valve assemblies 200, the control system 636, one or more other computing devices 638, or any combination thereof through the network 602.

The computing device 638 may be coupled to one or more input devices 802, such as a keyboard, a stylus, a mouse, a pointer, a scanner, a camera, a microphone, another input device, or any combination thereof. The computing device 638 may be coupled to one or more output devices 804, such as a display, a printer, a speaker, another output device, or any combination thereof. In some implementations, the input device 802 and the output device 804 may be implemented as a touchscreen 806.

The computing device 638 may include one or more I/O interfaces 812 configured to couple to the input devices 802 and the output devices 804 (or the touch screen 806). The computing device 638 may further include communication circuitry 808 configured to couple to the network 602. The computing device 638 may include one or more processors 810 coupled to the I/O interfaces 812 and to the communication circuitry 808.

The computing device 638 may include a memory 812 coupled to the processor 810. The memory 812 may be a non-volatile memory, such as a flash drive, a hard disc drive, or another non-volatile memory device. The memory 812 may store data and processor-readable instructions that may cause the processor 810 to perform one or more operations.

The memory 812 may include one or more communication modules 814 that may cause the processor 810 to receive data from one or more of the multiphase flowmeters 300 or the control system 636. The communication modules 814 may cause the processor 810 to communicate requests, data, alerts, or other information to the control system 636.

The memory 812 may include one or more operating system modules 816 that may cause the processor 810 to perform various computer operations. The memory 812 may include an Internet browser application 818 that may cause the processor 810 to access web pages over the Internet and to present a graphical interface including data and user-selectable controls that may be accessed by a user to view data.

The memory 812 may include one or more other modules 820 that may cause the processor 810 to perform a variety of operations. In some implementations, the memory 812 may store alert data 822. The alert data 822 may include data received from one or more of the control system 636 or the multiphase flowmeters 300. In some implementations, the alert data 822 may be presented within a graphical interface rendered by the Internet browser application 818 or in another application, such as a text message application. Other implementations are also possible.

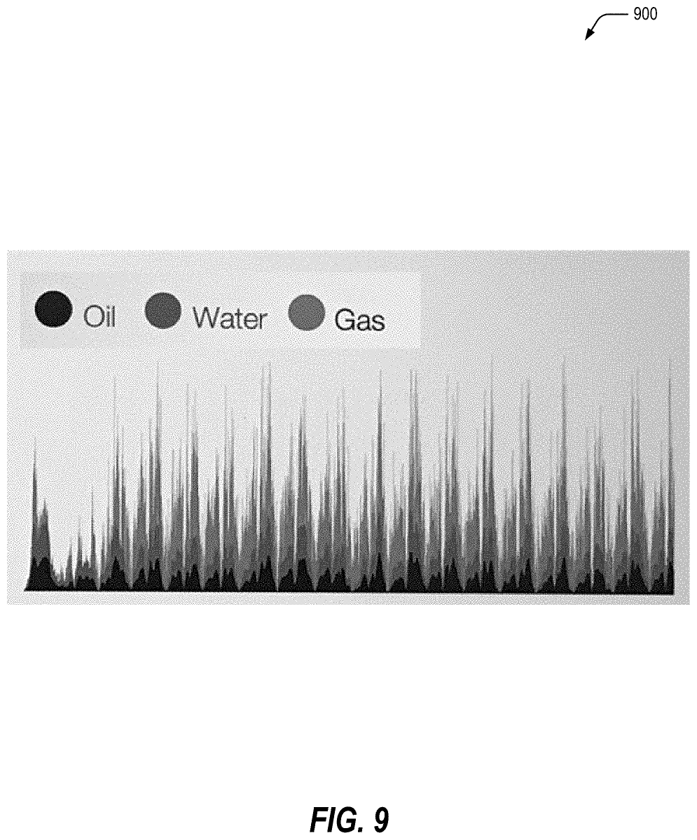

FIG. 9 depicts a graph 900 of frequency versus time for oil, gas, and water passing through the multiphase flowmeter 300 of FIGS. 2-8 coupled to a pump jack well, in accordance with certain embodiments of the present disclosure. The graph 900 reflects frequency components determined from movement of the movable element 216. In some implementations, water, gas, and oil may be determined by comparing frequency components of movement of the movable element 216 to one or more thresholds. In an example, gas volume may be determined based on vibrations (or oscillations) of the movable element 216 over time. The vibrations (or oscillations) that have a frequency that is greater than a noise threshold may be indicative of gas moving the movable element 216.

The graph 900 depicts the naturally occurring vibrational differences (detected from movement of the movable element 216) in response to packets of high frequency compressible gases pushing past the movable element 216 as compared to lower frequency incompressible water and incompressible oil in the fluid mixture. In some implementations, the cut of water versus oil may be determined based on one or more of the flow rate, position data associated with the check disk, changes in a dielectric of the fluid mixture, salinity data, moisture data, temperature data, chemical data, spectrometry data, or other data.

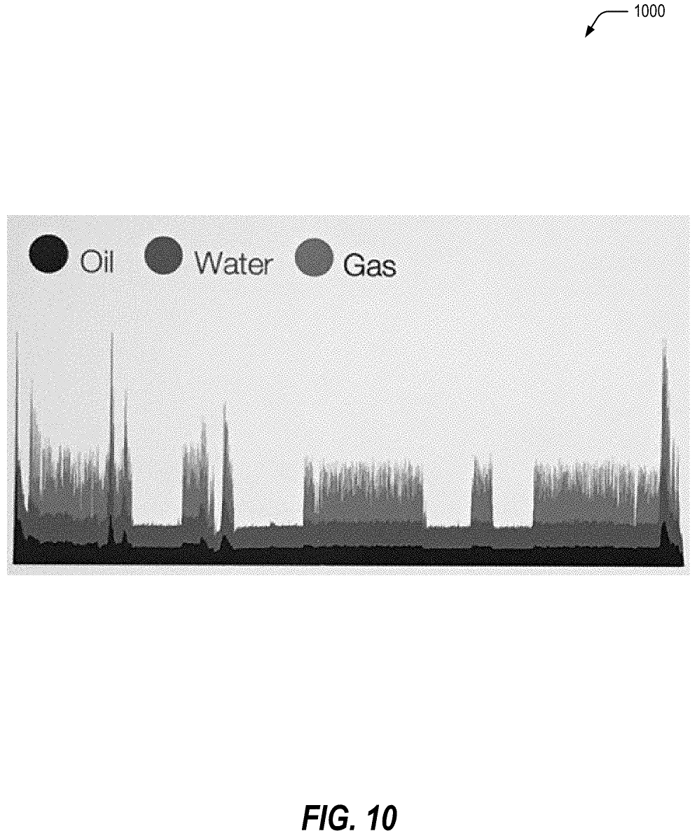

In the graph 900, the spacing between the various peaks may be caused by the frequency of the pump jack. The graph 900 may have a different frequency distribution in response to a different type of well pump. Another example is provided below with respect to FIG. 10 that shows the frequency distribution with respect to a multiphase flowmeter 300 that is coupled to a progressive cavity pump well.

FIG. 10 depicts a graph 1000 of frequency versus time for oil, gas, and water passing through the multiphase flowmeter 300 of FIG. 3 coupled to a progressive cavity pump well, in accordance with certain embodiments of the present disclosure. In this example, the water and oil components are more consistent, and the gas frequencies are clustered in conjunction with the pump action of the progressive cavity pump.

In this example, the position data may include clusters of high amplitude (and high frequency) vibrations (or oscillations) representing packets of gas moving the movable element 216 rapidly, which is indicative of gas. The gaps between the high amplitude (and high frequency) clusters of movement data may represent the portion of the flow where little to no gas is passing through the flowmeter 300. As discussed above, the gas may separate from the fluid mixture as it flows into the expansion chamber 212 and changes direction as it moves from the inlet 208 to the outlet 210 through the flowmeter 300.

In FIGS. 9 and 10, the volumes may be corrected for temperature and pressure and may be streamed as ModBus channel traces to the control system 636 or communicated as raw through a network connection through the network 602 to the control system 636. In other implementations, the processor 338 of the multiphase flowmeter 300 may determine flow rate and the cut of gas, oil, and water based on one or more of the flow rate, position data associated with the movable element 216, changes in a dielectric of the fluid mixture, salinity data, moisture data, temperature data, chemical data, spectrometry data, or other data. Other implementations are also possible.

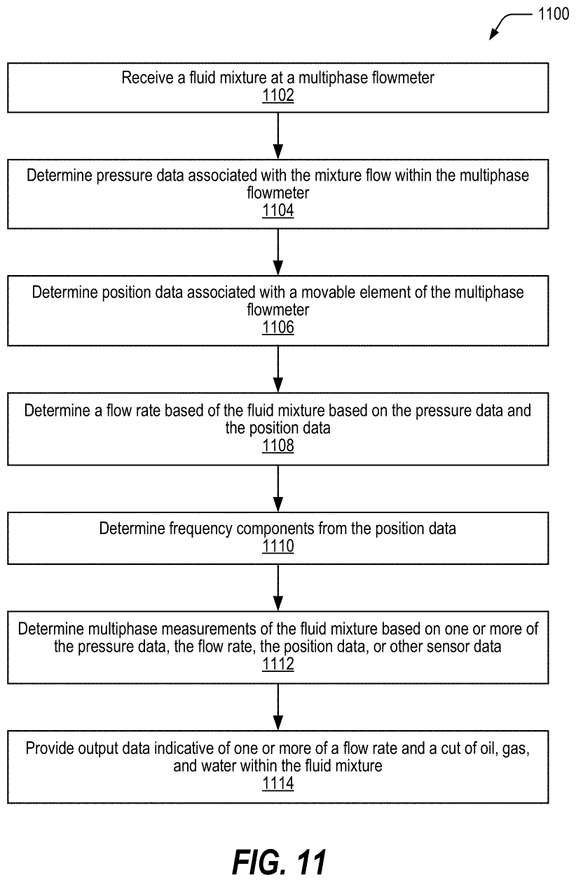

FIG. 11 is a flow diagram of a method 1100 of providing an output indicative of a multiphase measurement, in accordance with certain embodiments of the present disclosure. At 1102, the method 1100 may include receiving a fluid mixture at a multiphase flowmeter 300. The fluid mixture may be a crude mixture of oil, gas, water, debris, or any combination thereof

At 1104, the method 1100 may include determining pressure data associated with a fluid mixture at the multiphase flowmeter 300. In an example, one or more pressure sensors 314 may measure the fluid pressure at or near the outlet chamber 340 in which the movable element 216 moves.

At 1106, the method 1100 may include determining position data associated with the movable element 216 of the multiphase flowmeter 300. The movable element 216 may move in response to fluid pressure from the fluid mixture, opening and closing the valve 302 based on the fluid pressure. A spring 324 may bias the movable element 216 closed, and the fluid pressure may push the movable element 216 open. As discussed with respect to FIG. 3, a piston rod 330 coupled to the movable element 216 may move in response to movement of the movable element 216, and a position sensor 336 may produce signals indicative of the position of the piston rod 330 as the movable element 216 moves between an open position and a closed position. These signals may be sampled to produce position data corresponding to the position of the movable element 216.

At 1108, the method 1100 may include determining a flow rate of the fluid mixture based on the pressure data and the position data. In some implementations, the position of the movable element 216 may be indicative of the fluid pressure. Moreover, the valve 302 may provide a differential pressure between chamber 212 and the outlet chamber 340, which has a time-varying cross-section that may change with the fluid pressure (by virtue of the movement of the movable element 216). The position of the movable element 216 may be indicative of the fluid pressure at the movable element 216, and the changes in position of the moveable 216 may alter the cross-sectional area of the outlet chamber 340, producing a variable Venturi that may be used to determine the flow rate across a wide range of flow volumes and pressures.

At 1110, the method 1100 may include determining frequency components from the position data. In particular, the position of the movable element 216 varies over time, and the frequency of the variance may be determined from the position data. As previously discussed, the vibrations (frequency of positional change) of the movable element 216 may be indicative of gas packets pushing through the opening of the seat 222 and moving the movable element 216 rapidly.

At 1112, the method 1100 may include determining multiphase measurements of the fluid mixture based on one or more of the pressure data, the flow rate, the position data, or other sensor data. In some implementations, the circuit 224 or the control system 636 may determine liquid phase and gas phase components of the fluid mixture from the frequency components. The circuit 224 or the control system 636 may determine the cut of water versus other liquid based on one or more of the dielectric of the fluid mixture, the salinity of the fluid mixture, or a chemical composition of the fluid mixture (which may be determined using chemical sensors, spectrometry sensors, or other sensors). In one possible example, the circuit 224 or the control system 636 may determine the cut of oil versus water within the fluid mixture based on a pressure gradient determined from one or more of the pressure measurements and the position of the movable element 216. Other implementations are also possible.

At 1114, the method 1100 may include providing output data indicative of one or more of a flow rate and a cut of oil, gas, and water within the fluid mixture. In some implementations, the output may be provided by one or more of the circuit 224 or the control system 636. The output may be sent to a computing device 638 or to the control system 636 through the network 602 or through a wired connection. In some implementations, the output may include data provided within a graphical interface, which may be provided to a display device or rendered within an Internet browser application. Other implementations are also possible.

In conjunction with the systems, methods, and devices described herein with respect to FIGS. 1-11, embodiments of a multiphase flowmeter 300 are described that may include an inlet 206 to receive a fluid mixture (oil, gas, water, and sediment), an outlet 208 to provide the fluid mixture to a conduit, and a chamber 212 extending between the inlet 208 and the outlet 210. The chamber 240 may include a seat 222 defining a throat or narrow opening within the chamber 212 and between the inlet 208 and the outlet 210. The multiphase flowmeter 300 may include a movable element 216 biased against the seat 222 by a bias mechanism, such as a spring 324, and configured to move away from the seat 222 in response to pressure from a fluid mixture. The multiphase flowmeter 300 may include one or more positions sensors 336 configured to produce signals indicative of a position of the movable element 216. The multiphase flowmeter 300 may further include one or more pressure sensors 314 configured to determine a pressure of the fluid mixture within one or more of the inlet 206, the outlet 208, the chamber 212, or the outlet chamber 340 in which the movable element 216 moves.

The multiphase flowmeter 300 may include an upper housing 304 including a circuit 224 that may be configured to determine position data corresponding to the position of the movable element 216, a flow rate of the fluid mixture, and frequency components of the position data. The circuit 224 may determine a flow rate based on pressure data from the pressure sensors 314 and position data from the position sensors 336. The circuit 224 may determine gas content within the fluid mixture based on frequency components in the position data. The circuit 224 may determine a cut of water and oil based on one or more of the flow rate, the pressure data, the position data, and other sensor data. The other sensor data may include dielectric data, chemical data, spectrometry data, or other data.

In some implementations, the circuit 224 may capture the measurement data and may communicate the measurement data to the control system 636, which may determine the flow rate, and which may determine the cut of oil, gas, and water within the fluid mixture based on the measurement data. In other implementations, the circuit 224 may include a processor 338 configured to determine the flow rate and which may determine the cut of oil, gas, and water within the fluid mixture. In some implementations, the circuit 224 or the control system 636 may send data to one or more computing devices 638, which data may include information related to one or more of the flow rate, the cut of oil, gas, and water, or an error event that may indicate a valve assembly that may be in need of service. Other implementations are also possible.

Although the present invention has been described with reference to preferred embodiments, workers skilled in the art will recognize that changes may be made in form and detail without departing from the scope of the invention.

What is claimed is:

1. A multiphase flowmeter comprises:
an inlet configured to receive a fluid mixture;
an outlet configured to provide the fluid mixture to a conduit;
a chamber extending between the inlet and the outlet;
a seat defining a throat within the chamber;
a movable element biased against the seat and configured to move in response to pressure of the fluid mixture; and
a circuit including:
one or more position sensors to determine position data related to a position of the movable element;
one or more pressure sensors configured to determine pressure data associated with the fluid mixture in the chamber; and
a processor coupled to the one or more position sensors and to the one or more pressure sensors, the processor configured to determine a flow rate and cut data of the components of the fluid mixture that is flowing through the chamber based on the position data, the pressure data, and other data.

2. The multiphase flowmeter of claim 1, wherein the processor is configured to determine one or more frequency components within the position data and to determine a volume of gas from the fluid mixture based on the one or more frequency components.

3. The multiphase flowmeter of claim 1, wherein the processor is configured to determine a flow rate of liquid components of the fluid mixture based on the position data and the pressure data.

4. The multiphase flowmeter of claim 1, wherein:
the one or more position sensors are exposed to the fluid mixture; and
the processor is configured to determine a cut of oil and water within the fluid mixture based on a dielectric of the fluid mixture determined from a change in capacitance of the one or more position sensors.

5. The multiphase flowmeter of claim 1, wherein the processor is configured to determine vibrations of the movable element based on the position data and to determine a volume of gas flow through the chamber based on the vibrations.

6. The multiphase flowmeter of claim 1, wherein the circuit includes a cut sensor to determine the cut of oil and water within the fluid mixture.

7. The multiphase flowmeter of claim 1, wherein the movable element within the chamber provides a variable cross-sectional area within the chamber that varies with the fluid pressure to produce a variable Venturi as the fluid mixture flows through the chamber.

8. The multiphase flowmeter of claim 1, further comprising an upper housing including a fluid flow path around the one or more position sensors and including a return path to the chamber, wherein the fluid flow path prevents hydraulic pistoning of the movable element.

9. The multiphase flowmeter of claim 1, wherein:
the inlet includes a first cross-sectional area;
the outlet includes a second cross-sectional area that is approximately equal to the first cross-sectional area; and
the chamber includes a third cross-sectional area that is greater than the first cross-sectional area; and
entrained gas expands and separates from the fluid mixture within the chamber causing the movable element to vibrate rapidly.

10. The multiphase flowmeter of claim 1, wherein the movable element comprises a check disk of a valve.

11. A multiphase flowmeter comprising:
a circuit comprising:
a pressure sensor configured to determine pressure data associated with a fluid mixture flowing through a chamber from an inlet to an outlet;
one or more position sensors configured to determine position data associated with a position of a movable element within the chamber that is configured to move in response to pressure of the fluid mixture; and
a processor configured to determine:
a flow rate of the fluid mixture based on the pressure data and the position data;
first volumes of gas and liquid within the fluid mixture based on frequency data determined from the position data; and
second volumes of water and oil within the fluid mixture based on one or more of a cut sensor or a change in an electrical parameter of the one or more position sensors.

12. The multiphase flowmeter of claim 11, wherein:
the inlet includes a first cross-sectional area;
the outlet includes a second cross-sectional area that is approximately equal to the first cross-sectional area; and
the chamber includes a third cross-sectional area that is greater than the first cross-sectional area; and
entrained gas expands and separates from the fluid mixture within the chamber causing the movable element to vibrate rapidly.

13. The multiphase flowmeter of claim 11, wherein:
the one or more position sensors are exposed to the fluid mixture; and
the processor is configured to determine a cut of oil and water within the fluid mixture based on a dielectric of the fluid mixture determined from a change in capacitance of the one or more position sensors.

14. The multiphase flowmeter of claim 11, wherein the processor is configured to determine vibrations of the movable element based on the position data and to determine a volume of gas flow through the chamber based on the vibrations.

15. The multiphase flowmeter of claim 11, wherein the movable element within the chamber provides a variable cross-sectional area within the chamber that varies with the fluid pressure to produce a variable Venturi as the fluid mixture flows through the chamber.

16. The multiphase flowmeter of claim 11, further comprising:
a valve comprising:
the inlet configured to receive the fluid mixture;
the outlet configured to provide the fluid mixture to a conduit;
the chamber extending between the inlet and the outlet;
a seat defining a throat within the chamber;
a movable element biased against the seat and configured to move in response to the pressure of the fluid mixture.

17. The multiphase flowmeter of claim 11, further comprising an upper housing including a fluid flow path around the one or more position sensors and including a return path to the chamber, wherein the fluid flow path prevents hydraulic pistoning of the movable element.

18. A multiphase flowmeter comprising:
a valve comprising:
an inlet coupled to a first conduit to receive a fluid mixture;
an outlet above the inlet chamber and configured to provide the fluid mixture to a second conduit;
a chamber extending between the inlet and the outlet;
a seat defining a throat within the chamber; and
a movable element within the chamber and biased against the seat, the movable element configured to move in response to pressure from the fluid mixture; and
a circuit comprising:
a pressure sensor coupled to the chamber and configured to determine pressure data associated with the fluid mixture;
one or more position sensors configured to determine position data associated with a position of the movable element; and
a processor configured to determine:
a flow rate of the fluid mixture based on the pressure data and the position data;
a gas volume within the fluid mixture based on vibrations of the movable element determined from the position data; and
a cut of oil and water within the fluid mixture based on an electrical parameter determined from the one or more position sensors.

19. The multiphase flowmeter of claim 18, wherein:
the inlet includes a first cross-sectional area;
the outlet includes a second cross-sectional area that is approximately equal to the first cross-sectional area; and
the chamber includes a third cross-sectional area that is greater than the first cross-sectional area; and
entrained gas expands and separates from the fluid mixture within the chamber causing the movable element to vibrate rapidly.

20. The multiphase flowmeter of claim 18, further comprising:
one or more sensors including one or more of a salinity sensor, a chemical sensor, or a spectrometry sensor; and
wherein the circuit is configured to determine a water cut and an oil cut of the fluid mixture based on signals from the one or more sensors.
